(19) United States
(12) Patent Application Publication
(10) Pub. No.: US 2007/0039698 A1
(43) Pub. Date: Feb. 22, 2007

(54) Winding-up screen device

(75) Inventors: Mitsuhiko Chino, Tokyo (JP); Yoji Kamosawa, Tokyo (JP); Hirotsugu Toda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Seiki Hanbai CO., LTD., Tokyo (JP)

(21) Appl. No.: 10/557,844

(22) PCT Filed: May 10, 2004
(86) PCT No.: PCT/JP04/06572

§ 371 Date: Nov. 21, 2005

(30) Foreign Application Priority Data
May 21, 2003 (JP) 2003-143862

(51) Int. Cl. E06B 9/06

(52) U.S. Cl. 160/84.06

(57) ABSTRACT

A winding-up screen device in which, when a screen is wound around a winding axis, a screen guide for guiding the edge portion of the screen unwound from the winding axis is not left on the opening frame of a building. A joining groove is provided in the screen guide provided so as to go in and out between an opening frame and a fixed frame or a movable frame of the building, a joining part is attached to the edge portion, to be guided by the screen guide, of a screen, the screen guide goes in and out when the screen is wound and unwound by operation of the movable frame, and the joining part of the unwound screen is joined to the joining groove of the screen guide so as to freely slide.

### TECHNICAL FIELD

The present invention relates to a winding-up screen device attached to an opening frame of a building for the purpose of dust resistance, glare protection, heat insulation, mothproof, and others.

### BACKGROUND ART

Up to now, a winding-up screen device, in which a screen wound around a winding axis is supported between a fixed frame fixed in an opening frame of a building and a movable frame going to and coming back from the fixed frame and opening and closing operation can be performed in such a way that the screen is wound around the winding axis or unwound by the going and coming back movement of the movable frame, is well known.

Now, in such a winding-up screen device, since a gap is easily formed between both end portions of the screen unwound from a winding axis and an opening frame of a building, not only the outward appearance is poor, but also insects such as mosquitoes, flies, etc., easily enter the room through the gap particularly when the screen is an insect prevention net.

Then, in order to solve such a problem, in Japanese Examined Patent Application Publication No. 01-061158, a winding-up window screen device, in which one half of a tape as a slide fastener having many protrusion portions on one side thereof is attached to the edge portion of an insect prevention net, a rail having a groove is provided on an opening frame of a building, the one half of a tape as a slide fastener is passed through the groove of the rail so as to slide freely, and the protrusion portions are joined so as to slide freely, is proposed.

However, in such a winding-up window screen device disclosed in the above patent document, it is required to fix the rail having a groove for guiding the edge portion of an insect prevention net to the opening frame of a building and accordingly, even if the insect prevention net is wound around a winding axis to make the opening portion open, the rail having a groove is left on the opening frame and the external appearance is harmed. Moreover, when the above winding-up window screen device is used as a vertical opening type in which the opening and closing operation is performed upward and downward, the opening width is narrowed as much as the height of the rail, and, when it is used as a horizontal opening type in which the opening and closing operation is performed in the horizontal direction, the opening height is narrowed as much as the height of the rail and a difference in level because of the rail is formed on the floor where the lower frame of the opening frame is formed which may cause an obstacle when going in and out of a room through the opening frame is performed.

### DISCLOSURE OF INVENTION

The present invention has been made to solve such a problem, and it is an object of the invention to provide a winding-up screen device in which, when a screen is wound around a winding axis to make the opening portion open, a screen guide for guiding the edge portion of the screen unwound from the winding axis is not left on the opening frame of a building.

In order to solve the above problem, a winding-up screen device according to the present invention comprises a fixed frame fixed to an opening frame of a building; a movable frame provided so as to be parallel to the fixed frame and movable to and from the fixed frame; a screen wound around a winding axis, the screen provided so as to extend between the fixed frame and the movable frame, and the screen to be opened and closed by winding and unwinding the screen around the winding axis with the forward and backward movement of the movable frame; and a screen guide formed so as to be long and bendable, going in and coming out of the inner portion of the fixed frame or the movable frame through the opening provided at the end portion of the fixed frame or the movable frame with the forward and backward movement of the movable frame, and linearly led out along the edge portion of the screen unwound from the winding axis and guiding the edge portion. In the winding-up screen device, a joining part is attached to the screen along the edge portion to be guided by the screen guide, the screen guide contains a plurality of guide parts in which a joining groove is provided in the axial direction on the inner surface disposed on the screen side and is formed by connecting neighboring guide parts at both sides sandwiching the joining groove on the inner surface so as to be bendable, and the joining part of the screen unwound from the winding axis is joined to the joining groove of the screen guide led out from the fixed frame or the movable frame so as to slide freely.

In this way, according to the winding-up screen device of the present invention, when the screen is wound around the winding axis to make the opening portion open, since the screen guide for guiding the end portion of the screen unwound from a winding axis is housed in the inner portion of the fixed frame or the movable frame and not left on the opening frame, the screen guide does not harm the external appearance and narrow the width and height of the opening, and accordingly, does not produce a problem to go in and out of a room through the opening frame.

Here, the joining part can be formed, for example, in such a way that a plurality of protrusion portions are fixed along one end of a tape-like part fixed to the edge portion of the screen.

Then, in the winding-up screen guide, the guide part contains a pair of connection holes passing through in the axial direction on both sides sandwiching the joining groove on the inner surface and neighboring guide parts may be connected to each other by making flexible wire parts pass through in the pair of connection holes, or the guide part contains a pair of convex portions and a pair of concave portions for housing the convex portions on both sides sandwiching the joining groove on the inner surface and neighboring guide parts may be connected to each other by making the rotational axes and the bearing holes provided in the convex portions and the concave portions mate with each other. At this time, it is desirable that convex bending toward the inner surface of the screen guide due to the contact of the end faces in the axial direction of neighboring guide parts be suppressed.

Furthermore, in the winding-up screen device, one end of the screen guide is fixed to the fixed frame and the screen guide goes in and out of the inner portion of the movable frame with the forward and backward movement of the movable frame, and wherein one end of the screen is held in the movable frame, and the winding axis holding the other end of the screen and winding the screen may be supported in the inner portion of the fixed frame so as to be rotational, or one end of the screen guide is fixed to the movable frame and the screen guide goes in and out of the inner portion of the fixed frame with the forward and backward movement of the movable frame, and one end of the screen is held in the fixed frame and the winding axis holding the other end of the screen and winding the screen may be supported in the inner portion of the movable frame so as to be rotational. Then, it is desirable that the guide part contain a concave groove sitting astride a guide rail provided in a protruding condition on the opening frame on the surface opposite to the inner surface so as to freely slide and that the screen guide led out on the opening frame be guided by the guide rail, because the slide operation of the screen guide is more stabilized.

Moreover, in the winding-up screen device, the screen is opened and closed by horizontal movement of the movable frame and the screen guide can be led out along the lower edge portion of the screen unwound from the winding axis. At this time, the screen device may be constructed in such a way that a slide part is contained at the upper end of the movable frame and the movable frame is suspended from a slide frame fixed to the upper frame of the opening frame by using the slide part so as to freely slide. However, it is possible that the screen guide may led out along both edge portions of the screen unwound from the winding axis.

Moreover, in the winding-up screen device, it is desirable that a wiring mechanism in which the tension of extended cords maintains the fixed frame and the movable frame in balance be contained, and it is also desirable to use the screen formed by using an insect prevention net as a window screen device.

### BRIEF DESCRIPTION OF THE DRAWINGS

FIG. 1 is a front view showing a first embodiment of a winding-up screen device according to the present invention.

FIG. 2a is a sectional view taken on line A-A of FIG. 1.

FIG. 2b is a sectional view taken on line B-B of FIG. 1.

FIG. 2c is a perspective view of an essential part of FIG. 1.

FIG. 3a is a partially enlarged view of FIG. 1, showing an edge portion of a screen to which a joining part is attached.

FIG. 3b is a partially enlarged sectional view of FIG. 1, showing the state in which a joining part is joined to a joining groove of a screen guide so as to freely slide and the edge portion of a screen is guided by the screen guide.

FIG. 4a is an enlarged perspective view of a guide part of FIG. 1.

FIG. 4b is an enlarged perspective view of a screen guide of FIG. 1.

FIG. 5 is a front view showing a second embodiment of the winding-up screen device according to the present invention.

FIG. 6a is a sectional view taken on line C-C of FIG. 5.

FIG. 6b is a sectional view taken on line D-D of FIG. 5.

FIG. 6c is a perspective view of an essential part of FIG. 5.

FIG. 7 is a front view showing a third embodiment of the winding-up screen device according to the present invention.

FIG. 8 is a front view showing a fourth embodiment of the winding-up screen device according to the present invention.

FIG. 9a is a front view showing a fifth embodiment of the winding-up screen device according to the present invention.

FIG. 9b is a sectional view taken on line E-E of FIG. 9a.

FIG. 10a is a front view showing a sixth embodiment of the winding-up screen device according to the present invention.

FIG. 10b is a sectional view taken on line F-F of FIG. 10a.

FIG. 11a is a partially enlarged sectional view showing a first modified example of the guide part and screen guide.

FIG. 11b is a partially enlarged sectional view showing a second modified example of the guide part and screen guide.

FIG. 12a is an enlarged perspective view showing another form of the guide part.

FIG. 12b is an enlarged perspective view showing a screen guide formed by connecting the guide part of FIG. 12a.

### BEST MODE FOR CARRYING OUT THE INVENTION

Hereinafter, embodiments of a winding-up screen device according to the present invention are described in detail with reference to the drawings. However, in the following embodiments, although the winding-up screen device of the present invention used as an insect-prevention screen window to be horizontally opened and closed is described in detail, the winding screen device of the present invention is not limited to screen windows to be horizontally opened and closed, but also can be used as screen windows to be vertically opened and closed. Furthermore, its use is not limited to insect prevention, but also may be intended for shading, blindfold, heat insulation, etc.

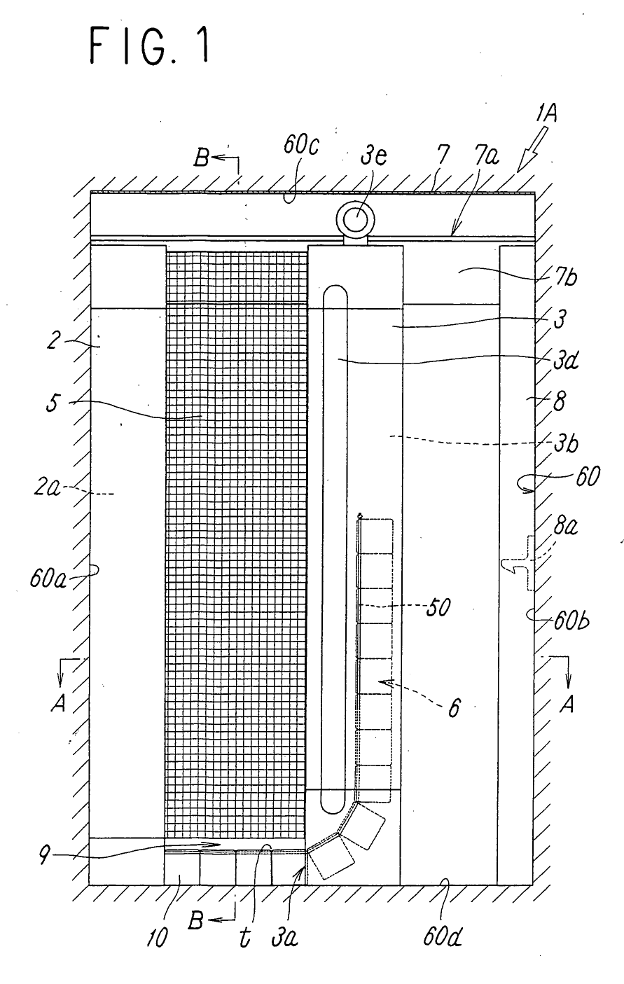

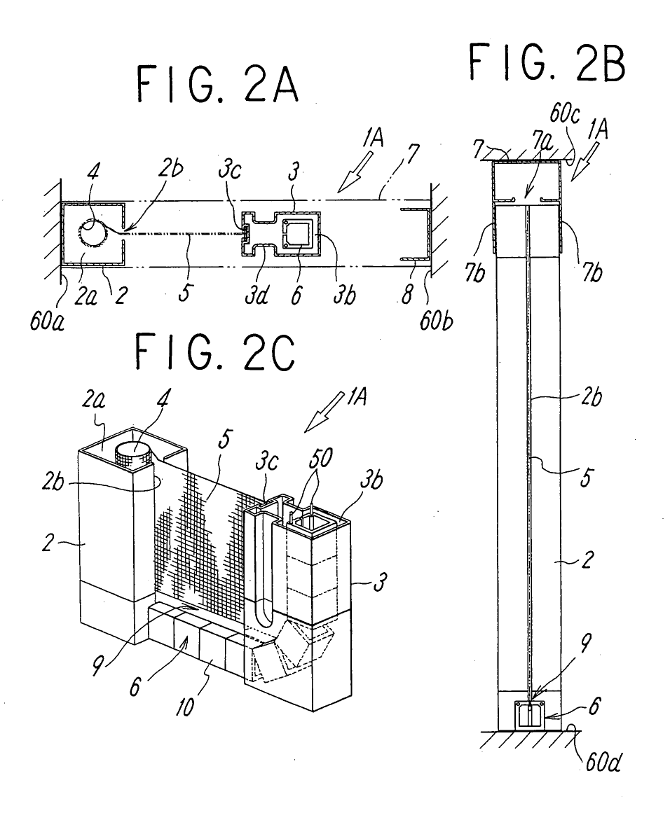

First, a first embodiment of the winding-up screen device according to the present invention is described based on FIG. 1 and FIGS. 2a to 2c. A winding-up screen device 1A, which is attached to an opening frame 60 made up of a pair of vertical frames 60a and 60b and a pair of upper and lower frames 60c and 60d as in a window frame, an entrance and exit, etc., in a building and is opened and closed sideways, contains a fixed frame 2 to be fixed to one vertical frame 60a of the opening frame 60, a movable frame 3 parallel to the fixed frame 2 and movable back and forth between the pair of vertical frames 60a and 60b, the screen 5 wound around a winding axis 4 inside the fixed frame 2, extended between the fixed frame 2 and the movable frame 3, and opened and closed in such a way that the screen 5 is wound around the winding axis 4 and unwound from that with the forward and backward operation of the movable frame 3, a screen guide 6 going in and out of the movable frame 3 with the forward and backward operation of the movable frame 3 and for guiding the lower edge portion of the screen unwound from the winding axis 4, a slide frame 7 for suspending the movable frame 3 so as to freely move in the operation direction, and a latch frame 8 fixed to the other vertical frame 60b of the opening frame 60 and for latching the movable frame 3 so as to be latched and be free from the latch.

The screen guide 6 is long and made bendable, one end of the screen guide 6 is fixed to the lower end portion of the fixed frame 2, and the other end as a free end is disposed in the inner portion 3b of the movable frame 3, and the screen guide 6 goes in and out of the inner portion 3b through an opening 3a provided at the lower end portion of the movable frame 3 with the opening and closing operation of the movable frame 3. Then, when the screen 5 is unwound from the winding axis 4 by the closing operation of the movable frame 3 (operation to the right in FIG. 1), the screen guide 6 is simultaneously linearly led out from the inside of the movable frame 3 on the lower frame 60d of the opening frame 60 along the lower edge portion of the screen 5 so as to guide the edge portion.

Furthermore, the latch frame 8 is formed so as to be substantially U-shaped in section, a latch portion 8a is provided in the latch frame 8, and the screen 5 unwound from the winding axis 4 is held in the opening frame 60 by latching the closed movable frame 3 to the latch portion 8a so as to be able to be made free again.

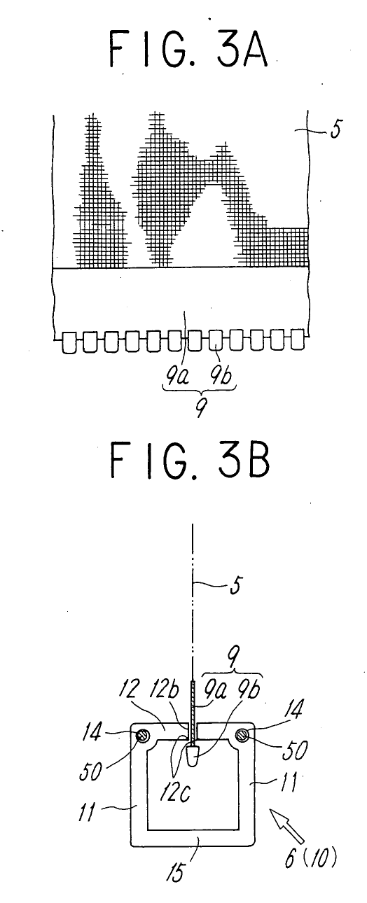

The screen 5 is made up of an insect-prevention net and, as shown in FIG. 3a and FIG. 3b, a joining part 9 is attached along the lower edge portion. Furthermore, in the screen guide 6, a joining groove 12b is provided on the inner surface 12a facing the lower edge portion of the screen 5 along the axial direction. Then, the joining part 9 of the screen 5 extended from the winding axis 4 is joined to the joining groove 12b guided out from the movable frame 3 so as to freely move. That is, the joining part 9 is joined to the joining groove 12b so as to be not able to be pulled out in the opening direction and to freely pass through in the length direction.

Accordingly, when the screen 5 as an insect-prevention net is unwound from the winding axis 4 by the closing operation of the movable frame 3, since no space is formed between the lower edge portion of the screen 5 and the screen guide 6 and between the screen guide 6 and the lower frame 60d in such a way that the joining part 9 of the screen 5 is joined to the joining groove 12b of the screen guide 6 guided out on the lower frame 60d so as to freely slide, it is able to prevent insects such as mosquitoes, flies, etc., from entering the room therefrom. Moreover, when the screen 5 is wound around the winding axis 4 by the opening operation (operation to the left direction in FIG. 1) of the movable frame 3, since the screen guide 6 is housed inside the movable frame 3 and not left on the lower frame 60d of the opening frame 60, the external appearance is not harmed and the opening height is not reduced because of the screen guide 6, and also the screen guide 6 does not prevent any one from entering a room through the opening frame 60.

When described more concretely, the above fixed frame 2 is hollow and, in its inner portion 2a, the above winding axis 4 for holding one end in the horizontal direction of the above screen 5 and winding the screen 5 is supported so as to be rotated. Then, a slit-shaped opening 2b for putting in and out the screen 5 is provided on the surface facing the movable frame 3 of the fixed frame 2 in the vertical direction (in the axial direction of the fixed frame 2), and, at the lower end portion of the surface, one end of the screen guide 6 is fixed so that the bottom surface of the screen guide 6 may be flush with the lower end surface of the fixed frame 2. Here, an automatic winding mechanism using a coil spring (not illustrated) is contained in the winding axis 4, a returning rotational force is stored in the coil spring when the screen 5 is unwound by the closing operation of the movable frame 3, and the screen 5 is made to be able to be wound around the winding axis 4 in such a way that the coil spring where the rotational force is stored becomes a driving force.

On the other hand, the movable frame 3 is also hollow, a joining groove 3c for holding the other end in the horizontal direction of the screen 5 is provided on the surface facing the fixed frame 2 in the vertical direction (in the axial direction of the movable frame 3), and handle concave grooves 3d for the opening and closing operation are provided on both sides. Then, an opening 3a for making the screen guide 6 move in and out of the inner portion 3b of the movable frame 3 is provided in the lower end portion on the surface facing the fixed frame 2; when the screen 5 is wound around the winding axis inside the fixed frame 2 by the opening operation of the movable frame 3, the screen guide 6 one end of which is fixed to the fixed frame 2 is housed in the inner portion 3b of the movable frame 3 starting with the other end as its free end; and, on the other hand, when the screen 5 is unwound from the winding axis 4 by the closing operation of the movable frame 3, the screen guide 6 housed in the inner portion 3b of the movable frame 3 is linearly led out on the lower frame 60d of the opening frame 60 from the opening 3a along the lower edge portion of the screen 5 to guide the edge portion of the screen 5.

Furthermore, a slide part 3e made up of a roller, etc., is provided at the upper end of the movable frame 3 and the movable frame 3 is suspended from the slide frame 7 so as to freely slide in such a way that the slide part 3e is joined to a slide rail 7a having an opening on the lower side of the slide frame 7 so as to freely slide. Moreover, the slide frame 7 is formed so as to be open downwards and substantially U-shaped in section, and both sides of the upper portion of the movable frame 3 are guided by a pair of guide walls opposite to each other.

The joining part 9 is composed of a tape-like part 9a and a plurality of protrusion portions 9b fixed along one end of the tape-like part 9a so as to be like a fastener, as shown in FIG. 3a and FIG. 3b, and the joining part 9 is attached to the edge portion of the screen 5 by fixing the tape-like part 9a along the lower edge portion of the screen 5 by welding, sticking, etc.

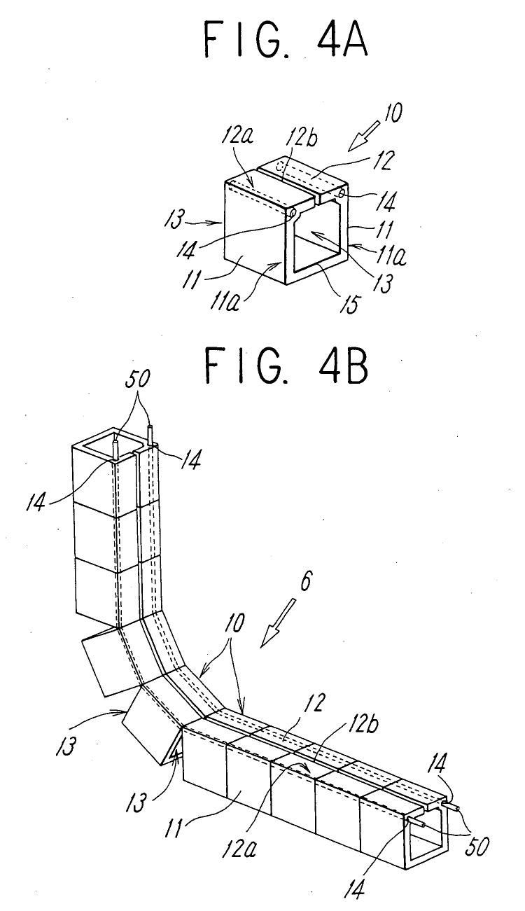

On the other hand, the screen guide 6 is composed of a plurality of guide parts 10, as shown in FIG. 4a and FIG. 4b, and formed by connecting these guide parts in a line using flexible wire parts 50.

The guide part 10 has a pair of side faces 11a and 11a and an inner surface 12a which is located between the upper portions of the pair of side faces 11a and 11a and is to be disposed on the screen side and has the joining groove 12b provided substantially in the middle of the inner surface 12a. Furthermore, connection holes 14 and 14 are provided along the joining groove 12b so as to pass through in the axial direction on both side portions sandwiching the joining groove 12b on the inner surface 12a of the guide part 10.

Then, the plurality of guide parts 10 are connected by passing the wire parts 50 and 50 through the connection holes 14 and 14 so as to be bendable toward the side of the inner surface 12a, that is, toward the side of the screen 5 to form the screen guide 6. Accordingly, the whole screen guide 6 is made possible to be bent so as to be concave toward the inner surface 12c, that is, toward the screen 5 to be guided.

More concretely, the guide parts 10, which are formed by injection molding of synthetic resin, are composed of a pair of side walls 11 and 11 forming the pair of side faces 11a and 11a, an inner wall 12 disposed between the upper end portions of the side walls and forming the inner surface 12a, and a connection wall 15 provided so as to hang between the pair of side walls 11 and 11 and connecting these to be formed in the axial direction and hollow and substantially rectangular in section. Then, each of the pair of side walls 11 and 11, the inner wall 12, and the connection wall 15 constituting the guide parts 10 is formed so as to be like a substantially rectangular plate, and the connection holes 14 are provided so as to pass through along both corner portions where the pair of side walls 11 and 11 intersect the inner wall 12. Moreover, the end portions of wire parts 50 and 50 are made to pass through the connection holes 14 and 14 and connect the guide parts 10 are properly treated so as not to be pulled out. Furthermore, the joining groove 12b is provided substantially in the middle of the inner wall 12 so as to pass through in the thickness direction. As shown in FIG. 3b, the tape-like part 9a of the joining part 9 attached to the end portion of the screen 5 is made to pass through the joining groove 12b so as to freely slide in the axial direction, the base portion of the protrusion portion 9b of the joining part 9 is made wider in width than the groove of the joining groove 12b, and the end portion of the screen 5 is joined so as to freely slide between opening edges 12c of the inner wall 12 of the joining groove 12b. Thus, the end portion of the screen 5 is guided by the screen guide 6.

Now, when the screen guide 6 is linearly led out along the edge portion of the screen 5 unwound from the winding axis 4 on the opening frame 60, the guide parts 10 are connected in such a way that the end faces 13 in the axial direction of neighboring guide parts 10 are made in contact with each other and disposed without a space therebetween. Therefore, the convex bending of the screen guide 6 toward the side of the screen 5 (the side of the inner surface 12a), that is, the floating of the screen guide 6 from the opening frame 60 is prevented as much as possible.

Moreover, in such a screen guide 6, when the screen guide 6 is put in and out of the inner portion 3b of the movable frame 3, it becomes possible to bend the screen guide 6 so as to be smoothly concave-shaped toward the side of the screen 5 (side of the inner surface 12a) in such a way that the wire part 50 is made slightly longer than the actual length of many connected guide parts 10 in accordance with the position of the connection hole 14 with reference to the inner surface 12a or that a tapered cut portion t as shown in FIG. 1 is formed in the corner portion where the inner surface 12a and the end face 13 cross in the guide part 10.

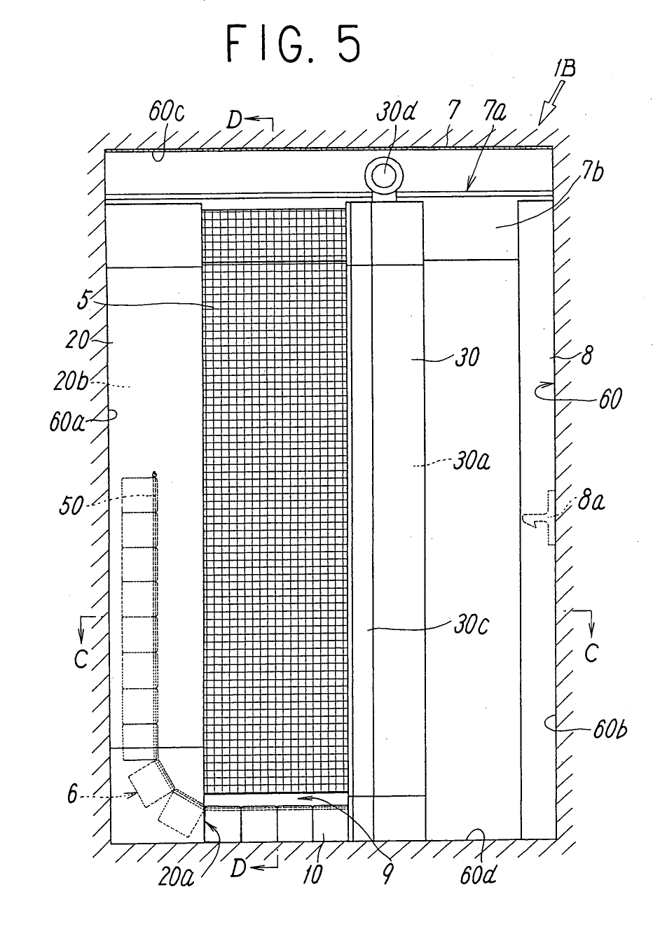

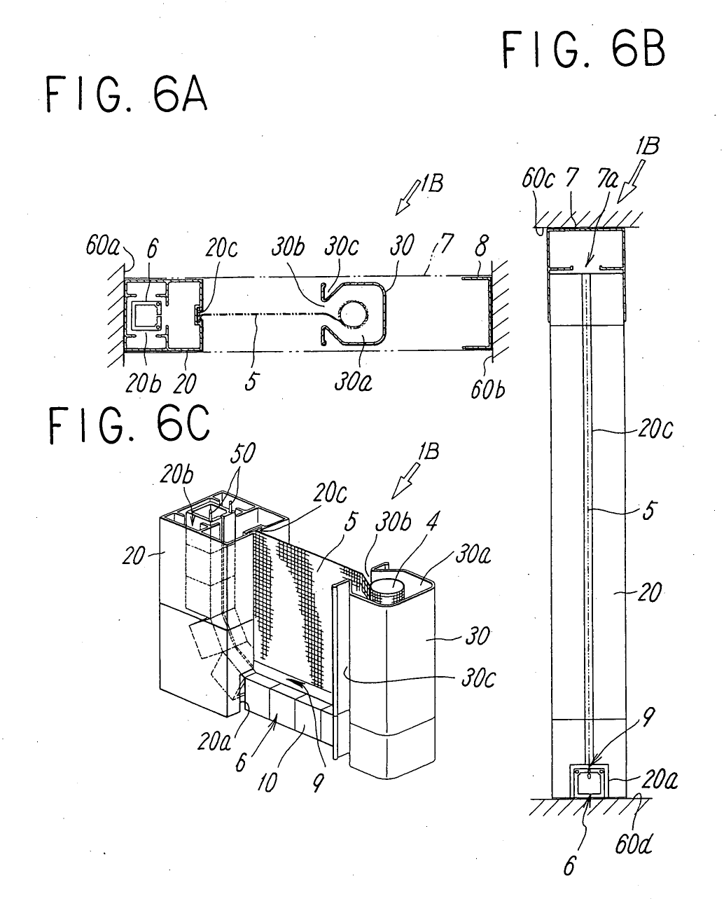

FIG. 5 and FIGS. 6a to 6c show a second embodiment of the winding-up screen device according to the present invention. Here, only the construction portions different from the winding-up screen device of the first embodiment are described and the other common construction parts are given the same reference numerals to avoid overlapping description.

The main difference of the screen device 1B of the second embodiment from the screen device 1A is in that one end of the screen guide 6 is fixed to the lower end portion of a movable frame 30 and the screen guide 6 goes in and out of the inner portion 20b of the fixed frame 20 through the opening 20a provided in the lower end portion of the fixed frame 2d with the opening and closing operation of the movable frame 30 and that one end in the horizontal direction of the screen 5 is held, the winding axis 4 for winding the screen 5 is supported inside the movable frame 30 so as to be able to be rotated, and the other end in the horizontal direction of the screen 5 is held in the fixed frame 20.

Concretely, the movable frame 30 is formed so as to be hollow and, in its inner portion 30a, the winding axis 4 is supported so as to be able to be rotated. Then, a slit-shaped opening 30b for putting in and out the screen 5 is provided on the surface facing the fixed frame 20 of the movable frame 30 in the vertical direction, and, at the lower end portion of the surface, one end of the screen guide 6 is fixed so that the bottom surface of the screen guide 6 may be flush with the lower end surface of the movable frame 30. Furthermore, handle grooves (concave parts) 30c for opening and closing operation are provided on both side faces of the movable frame 30. Moreover, a slide part 30d made up of a roller, etc., is provided at the upper end of the movable frame 30, and the movable frame 30 is suspended from the slide frame 7 so as to freely slide in such a way that the slide part 30d is joined to a slide rail 7a having an opening on the lower surface side of the slide frame 7 so as to freely slide.

On the other hand, fixed frame 20 is also formed so as to be hollow, a joining groove 20c for holding the other end in the horizontal direction of the screen 5 is provided in the vertical direction (in the axial direction of the fixed frame 20) on the surface facing the movable frame 30 of the fixed frame 20, and an opening 20a for putting the screen guide 6 in and out of the inner portion 20b of the fixed frame 20 is provided at the lower end portion of the surface.

Then, when the screen 5 is wound around the winding axis 4 inside the movable frame 30 by opening operation of the movable frame 30, the screen guide 60 one end of which is fixed to the movable frame 30 is housed in the inner portion 20b of the fixed frame 20 starting with the other end side through the opening 20a, and, in contrast with this, when the screen 5 is unwound from the winding axis 4 by closing operation of the movable frame 30, the screen guide 6 housed in the inner portion 20b of the fixed frame 20 is linearly led out along the lower edge portion of the screen 5 on the lower frame 60d of the opening frame 60 through the opening 20a to guide the edge portion of the screen 5.

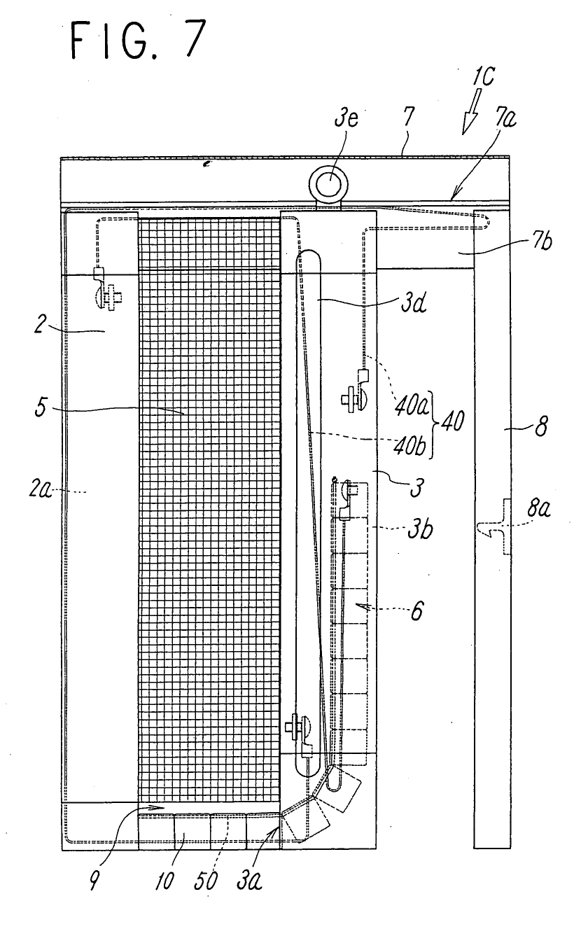

FIG. 7 shows a third embodiment of the winding-up screen device according to the present invention. Here, only the construction portions different from the winding-up screen device 1A of the first embodiment are described and the other common construction parts are given the same reference numerals to avoid overlapping description.

The main difference of the screen device 1C of the third embodiment from the screen device 1A is in that a wiring mechanism 40 in which extended cords 40a and 40b are hung to maintain the fixed frame 2 and the movable frame 3 in parallel with their tension is provided.

Concretely, one end of a first extended cord 40a is fixed to the inner portion 3b of the movable frame 3, the cord 40a is led to the upper portion of the movable frame 3, the cord 40a makes a turn at the upper end portion of the movable frame 3, the cord 40a is laid to the upper end portion of the latch frame 8 along the upper end portion of the screen device 1C, the cord 40a turns back at the upper end portion of the latch frame 8, the cord 40a is laid to the upper end portion of the fixed frame 2 along the upper end portion of the screen device 1C, the cord 40a makes a turn at the upper end portion of the fixed frame 2, the cord 40a is led to the lower end portion of the inner portion 2a of the fixed frame 2, the cord 40a makes a turn at the lower end portion of the fixed frame 2, the cord 40a is laid to the lower end portion of the movable frame 3 along the lower end portion of the screen device 1C, the cord 40a makes a turn at the lower end portion of the movable frame 3, and the other end is fixed to the inner portion 3b of the movable frame 3.

On the other hand, one end of a second extended cord 40b is fixed to the guide part 10 (free end of the screen guide 6) connected to the end of the movable frame 3 of the screen guide 6, the cord 40b is led to the lower end portion of the movable frame 3, the cord 40b turns back at the lower end portion of the movable frame 2, the cord 40b is led to the upper portion of the inner portion 3b of the movable frame 3, the cord 40b makes a turn at the upper end portion of the movable frame 3, the cord 40b is laid to the upper end portion of the fixed frame 2 along the upper end portion of the screen device 1C, the cord 40b makes a turn at the upper end portion of the movable frame 3, and the other end of the cord 40b is fixed to the inner portion 2a of the fixed frame 2.

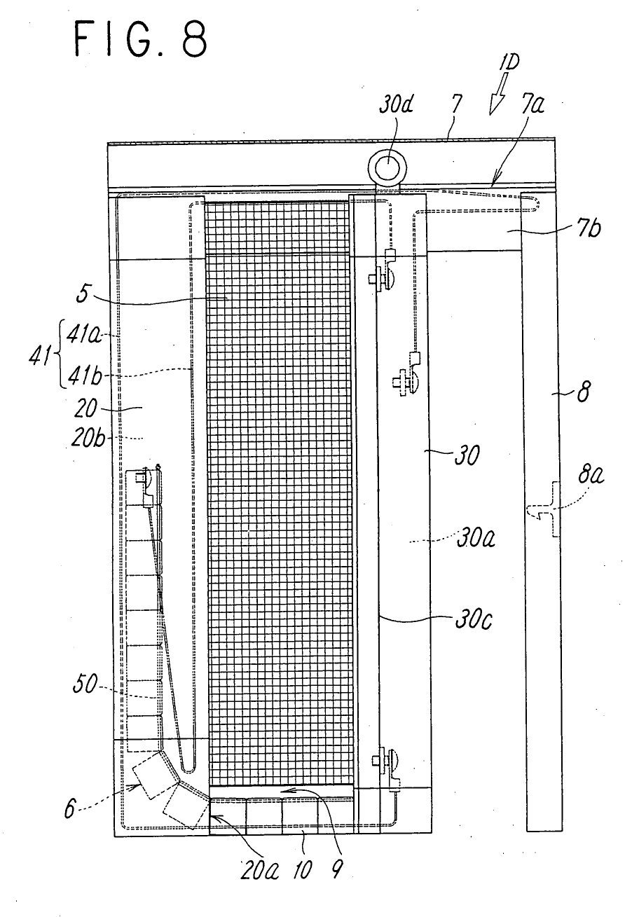

FIG. 8 shows a fourth embodiment of the winding-up screen device according to the present invention. Here, only the construction portions different from the winding-up screen device 1B of the second embodiment are described and the other common construction parts are given the same reference numerals to avoid overlapping description.

The main difference of the screen device 1D of the fourth embodiment from the screen device 1B is in that a wiring mechanism 41 in which extended cords 41a and 41b are hung to maintain the fixed frame 20 and the movable frame 30 in parallel with their tension is provided.

Concretely, one end of a first extended cord 41a is fixed to the inner portion 30a of the movable frame 30, the cord 41a is led to the upper portion of the movable frame 30, the cord 41a makes a turn at the upper end portion of the movable fame 30, the cord 41a is laid to the upper end portion of the latch frame 8 along the upper end portion of the screen device 1D, the cord 41a turns back at the upper end portion of the latch frame 8, the cord 41a is laid to the upper end portion of the fixed frame 20 along the upper end portion of the screen device 1D, the cord 41a makes a turn at the upper end portion of the fixed frame 20, the cord 41a is led to the lower end portion of the inner portion 20b of the fixed frame 20, the cord 41a makes a turn at the lower end portion of the fixed frame 20, the cord 41a is laid to the lower end portion of the movable frame 30 along the lower end portion of the screen device 1D, the cord 41a makes a turn at the lower end portion of the movable frame 30, and the other end of the cord 41a is fixed to the inner portion 30a of the movable frame 30.

On the other hand, one end of a second extending cord 41b is fixed to the inner portion 30a of the movable frame 30, the cord 41b is led to the upper end portion of the movable frame 30, the cord 41b makes a turn at the upper end portion of the movable frame 30, the cord 41b is laid to the upper end portion of the fixed frame 20 along the upper end portion of the screen device 1D, the cord 41b makes a turn at the upper end portion of the fixed frame 20, the cord 41b is led to the lower end portion of the inner portion 20b of the fixed frame 20, the cord 41b turns back at the lower end portion of the fixed frame 20, and the other end of the cord 41b is fixed to the guide part 10 (free end of the screen guide 6) connected to the very end in the fixed frame 20 of the screen guide 6.

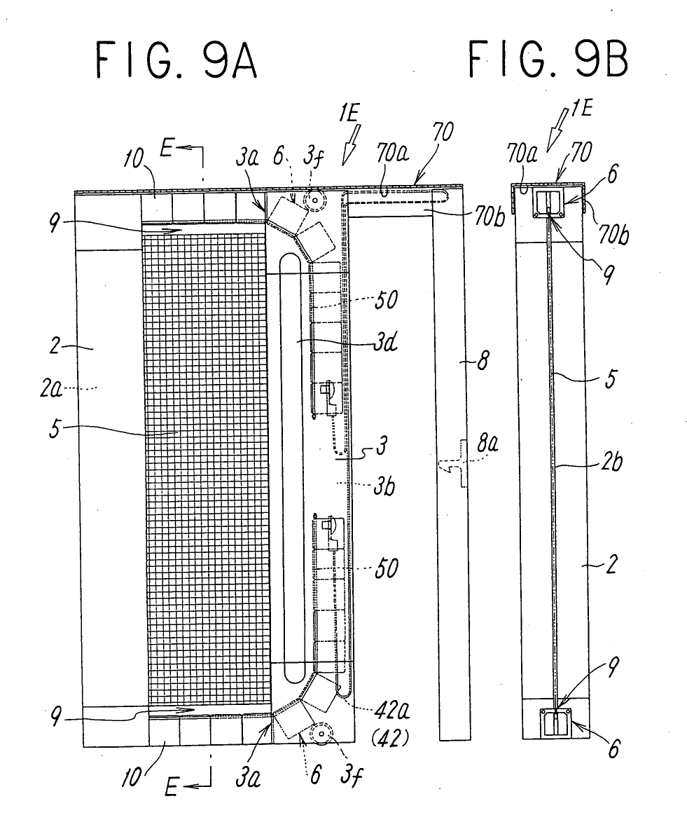

FIGS. 9a and 9b show a fifth embodiment of the winding-up screen device according to the present invention. Here, only the construction portions different from the winding-up screen device 1A of the first embodiment are described and the other common construction parts are given the same reference numerals to avoid overlapping descriptions.

The main difference of the screen device 1E of the fifth embodiment from the screen device 1A is in that a pair of screen guides 6 and 6 is provided to go in and out of the opening 3a and 3a at the lower end portion and the upper end portion of the movable frame 3 in accordance with the opening and closing operation of the movable frame 3, the screen guides 6 and 6 are led out along both upper and lower edge portions of the screen 5 unwound from the winding axis 4 in the fixed frame 2, and both edge portions are guided, and that a wiring mechanism in which an extended cord 42a is hung to maintain the fixed frame 2 and the movable frame 3 in parallel with its tension is provided.

Concretely, in the fixed frame 2 in the inner portion 2a of which the winding axis 4 is supported, one ends of the pair of screen guides 6 and 6 are fixed to the upper end portion and lower end portion of the surface facing the movable frame 3 in such a way that the bottom surface of the screen guides 6 and 6 is flush with the upper end surface and the lower end surface of the fixed frame 2.

On the other hand, in the movable frame 3, a pair of openings 3a and 3a making the pair of screen guides 6 and 6 go in and out of the inner portion 3b of the movable frame 3 is provided in the upper end portion and lower end portion of the surface facing the fixed frame 2.

Then, when the screen 5 is wound around the winding axis 4 inside the fixed frame 2 by the opening operation of the movable frame 3, the pair of screen guides 6 and 6 one end of which is fixed to the fixed frame 2 are housed in the inner portion 3b of the movable frame 3 starting with the other end through the openings 3a and 3a, and, in contrast with this, when the screen 5 is unwound from the winding axis 4 by the closing operation of the movable frame 3, a pair of screen guides 6 and 6 housed in the inner portion 3 of the movable frame 3 is linearly led out from the openings 3a and 3a onto the upper frame 60c and the lower frame 60d of the opening frame 60 along the upper and lower end portions of the screen 5 to guide both end portions.

Moreover, a pair of rollers 3f and 3f are provided at the upper and lower ends of the movable frames 3, and a slide frame 70 which is substantially U-shaped in section is mounted on the upper frame 60c of the opening frame 60 so as to be open downward. Then, on the upper end of the movable frame 3, the roller 3f rolls on the bottom surface 70a of the slide frame 70 and both side faces of the movable frame 3 are guided by a pair of guide walls 7b, facing each other, of the slide frame 70, and on the other hand, on the lower end of the movable frame 3, the roller 3f rolls on the lower frame 60d of the opening frame 60.

Furthermore, one end of the extended cord 42a is fixed to the guide part 10 (free end of the upper screen guide 6) connected to the very end in the movable frame 3 of the upper screen guide 6, the cord 42a turns back upward at the substantially middle portion in the inner portion 3b of the movable frame 3, the cord 42a is led to the upper end portion of the movable frame 3, the cord 42a makes a turn at the upper end portion of the movable frame 3, the cord 42a is laid to the upper end portion of the latch frame 8 along the upper end portion of the screen device 1E, the cord 42a turns back at the upper end portion of the latch frame 8, the cord 42a is laid to the upper end portion of the movable frame 3, the cord 42a makes a turn downward at the upper end portion of the movable frame 3, the cord 42a is led to the lower end portion of the inner portion 3b of the movable frame 3, the cord 42a turns back upward at the lower end portion of the movable frame 3, and the other end of the cord 42a is fixed to the guide part 10 (free end of the lower screen guide 6) connected to the very end of the movable frame 3 of the screen guide 6.

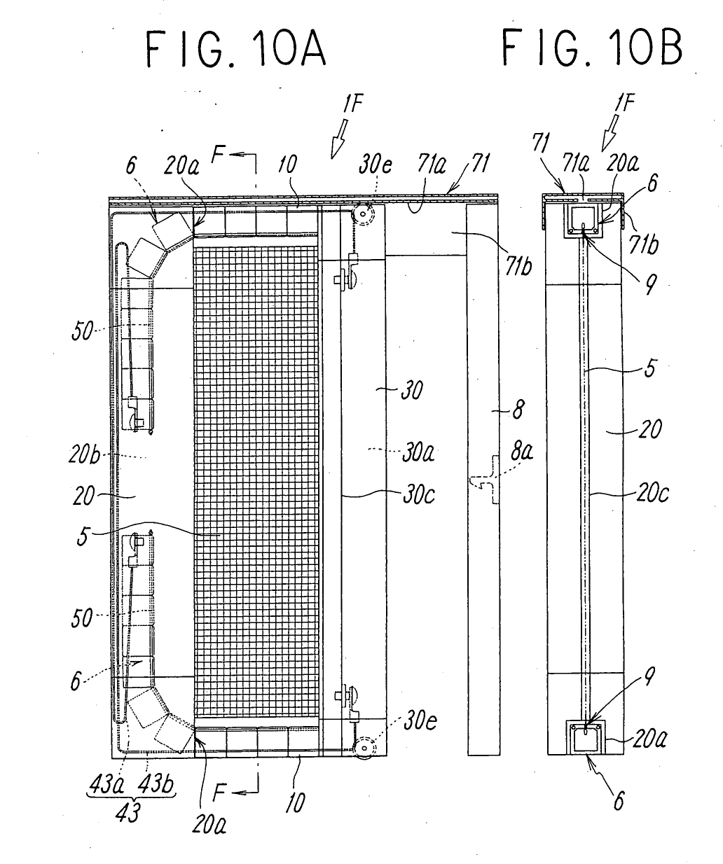

FIG. 10a and FIG. 10b show a sixth embodiment of the winding-up screen device according to the present invention. Here, only the construction portions different from the winding-up screen device 1B of the second embodiment are described and the other common construction parts are given the same reference numerals to avoid overlapping description.

The main difference of the screen device 1F of the sixth embodiment from the screen device 1B is in that, in accordance with the opening and closing operation of the movable frame 30, a pair of screen guides 6 and 6 are provided so as to be bent and go in and out of the inner portion 20b through the openings 20a and 20a of the lower end portion and upper end portion of the fixed frame 20 and, in accordance with the closing operation of the movable frame 30, the screen guides 6 and 6 are led out along the upper and lower edge portions of the screen 5 unwound from the winding axis 4 inside the movable frame 30 to be constituted so as to guide both end portions, and that a wiring mechanism 43 in which extended cords 43a and 43b provided to maintain the fixed frame 20 and the movable frame 30 in balance by their tension is contained.

Concretely, in the movable frame 30 in the inner portion 30a of which the above winding axis is supported, one end of the pair of screen guides 6 and 6 is fixed to the upper end portion and the lower end portion of the surface facing the fixed frame 20 so as to be substantially flush with the upper end surface and the lower end surface of the movable frame 30, respectively.

On the other hand, the pair of openings 20a and 20a where the pair of screen guides 6 and 6 go in and out of the inner portion 20b of the fixed frame 20 are provided at the upper end portion and lower end portion of the surface facing the movable frame 30 of the above fixed frame 20.

Then, when the screen 5 is wound around the winding axis 4 inside the movable frame 30 by the opening operation of the movable frame 30, the pair of screen guides 6 and 6 one end of which is fixed to the movable frame 30 is housed in the inner portion 20b of the fixed frame 20 starting with the other end of them through the openings 20a and 20a, and in contrast with this, when the screen 5 is unwound from the winding axis 4 by the closing operation of the movable frame 30, the pair of screen guides 6 and 6 housed in the inner portion 20b of the fixed frame 20 is linearly led out on the upper frame 60c and the lower frame 60d of the opening frame 60 along the upper and lower edge portions of the screen 5 from the openings 20a and 20a to guide both edge portions.

Moreover, a pair of rollers 30e and 30e are provided at the upper and lower ends of the movable frame 30, and a slide frame 71, which is substantially U-shaped in section, having a rail groove 71a is mounted on the upper frame 60c of the opening frame 60 so as to be open downward. Then, on the upper end of the movable frame 30, the roller 30e rolls along the rail groove 71a of the slide frame 71 and both side faces of the movable frame 30 are guided by a pair of guide walls 71b, facing each other, of the slide frame 71, and, on the other hand, on the lower end of the movable frame 30, the roller 30e rolls on the lower frame 60d of the opening frame 60.

Furthermore, one end of the extended cord 43a is fixed to the inner portion 30a of the movable frame 30 and led to the upper end portion of the movable frame 30, the cord 43a makes a turn at the upper end portion of the movable frame 30, the cord 43a is laid to the upper end portion of the fixed frame 20 along the upper end portion of the screen device 1F, the cord 43a makes a turn downward in the upper end portion of the fixed frame 20, the cord 43a is led to the lower end portion of the inner portion 20b of the fixed frame 20, the cord 43a turns back in the lower end portion of the fixed frame 20, and the other end of the cord 43a is fixed to the guide part 10 (free end of the lower screen guide 6) connected to the very end of the fixed frame 20 in the lower screen guide 6.

On the other hand, one end of the extended cord 43b is fixed to the inner portion 30a of the movable frame 30 and led to the lower end portion of the movable frame 30, the cord 43b makes a turn in the lower end portion of the movable frame 30, the cord 43b is laid to the lower end portion of the fixed frame 20 along the lower end portion of the screen device 1F, the cord 43b makes a turn upward in the lower end portion of the fixed frame 20, the cord 43b is led to the upper end portion of the inner portion 20b of the fixed frame 20, the cord 43b turns back in the upper end portion of the fixed frame 20, and the other end of the cord 43b is fixed to the guide part 10 (free end of the upper screen guide 6) connected to the very end of the fixed frame 20 of the upper screen guide 6.

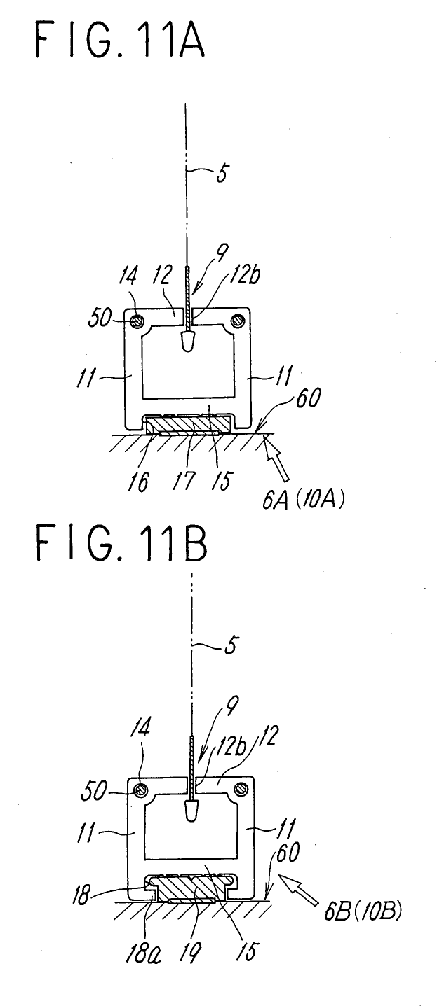

FIGS. 11a and 11b show modified examples of the screen guide 6 and the guide part 10. However, only the construction parts different from the screen guide 6 and the guide part 10 shown in FIG. 3b, FIG. 4a, and FIG. 4b are described and the other common construction parts are given the same reference numerals to avoid overlapping description.

In a guide part 10A of a screen guide 6A shown in FIG. 11a, a pair of side walls 11 and 11 is connected to each other by a connecting wall 15 in the middle portion thereof and a concave groove 16 is formed on the surface opposite to the inside surface 12a, that is, on the surface opposite to the screen 5 by the inner surfaces of the side walls 11 and 11 and the bottom surface of the connecting wall 15. Then, the screen guide 6B on the opening frame 60 is guided in such a way that the concave groove 16 sits astride a guide rail 17 provided in a protruding condition on the opening frame 60 so as to slide freely.

On the other hand, in a guide part 10B of a screen guide 6B shown in FIG. 11b, a concave groove 18 is formed in the same way as in the guide part 10A and alligator mouth portions 18a toward the inside are provided at each opening edge of the concave groove 18. Then, the screen guide 6B on the opening frame 60 is guided by the guide rail 19 in such a way that the concave groove 18 sits astride a substantially T-shaped guide rail 19, to which the alligator mouth portion is joined, provided in a protrusion condition on the opening frame 60 so as to slide freely. However, the screen guide 6B and the guide part 10B can be applied to a winding-up screen device of the type in which the screen guide goes in and out of the inner portion of the fixed frame as in the second embodiment, fourth embodiment, and sixth embodiment.

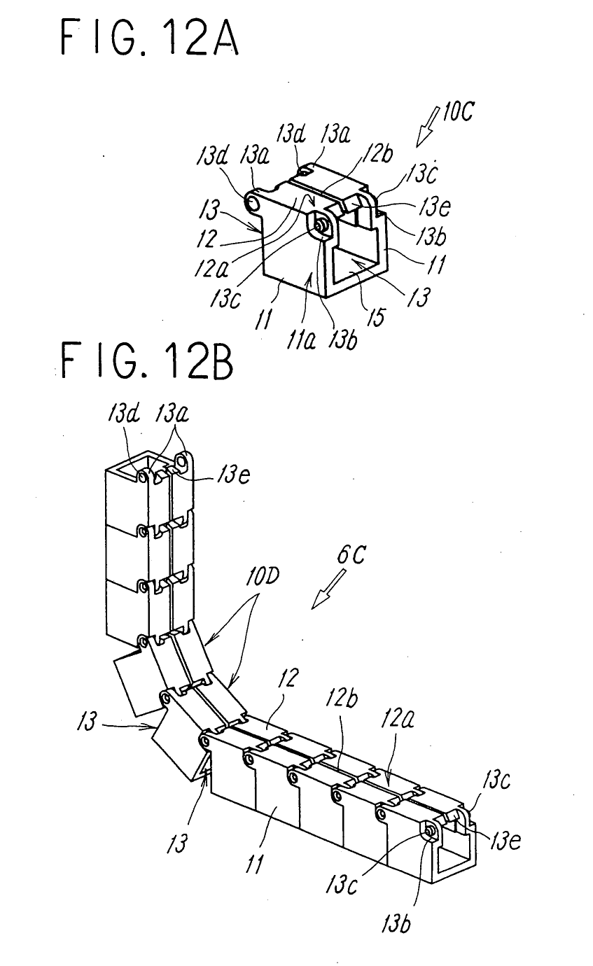

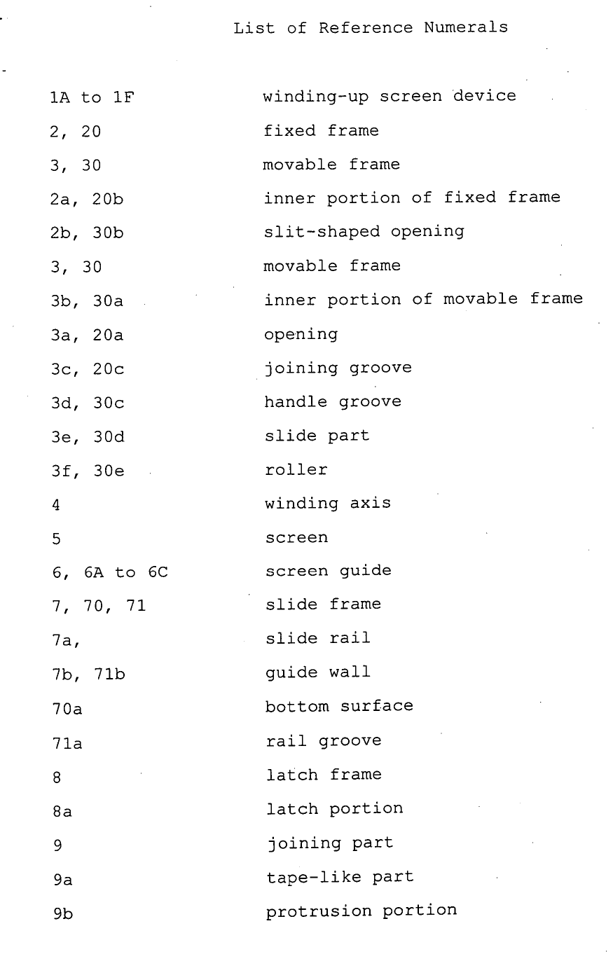

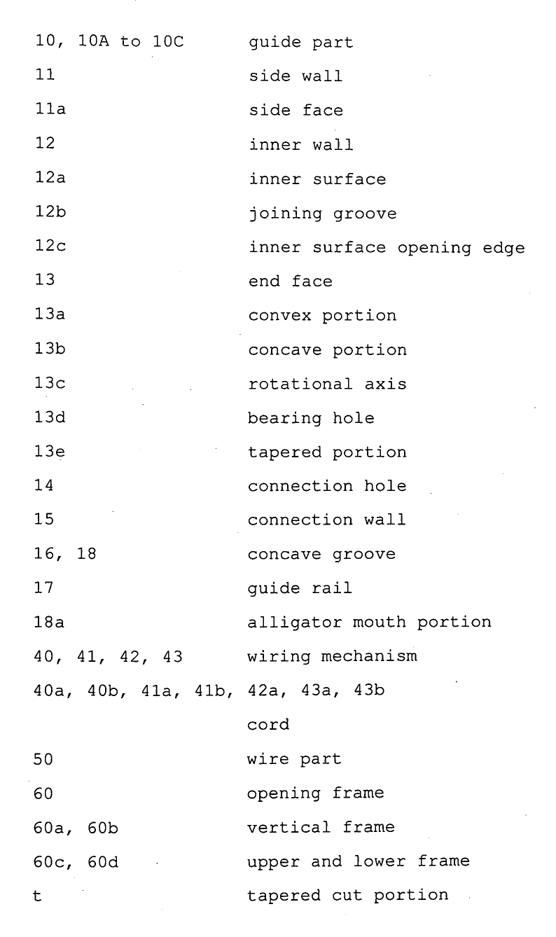

FIGS. 12a and 12b show a second form of screen guide and guide part. Moreover, here, the construction parts different from the screen guide 6 and guide part 10 shown in FIGS. 3b, 4a and 4b are described and the other common construction parts are given the same reference numerals to avoid overlapping description.

The guide part 10C shown in FIGS. 12a and 12b contains a pair of convex portions 13a provided in a protruding condition in a direction of axial line from one end face out of both end faces 13 and 13 in the axial direction on both sides sandwiching the joining groove 12b of the end portion on the side of the inner surface 12a and a pair of concave portions 13b formed so as to sit astride at least the other end face 13 and the inner surface 12a and housing the convex portions 13a of a neighboring guide part 10c, and rotational axes 13c and bearing holes 13d are formed to mate with the convex portions 13a and the convex portion 13b so as to rotate freely. Then, a plurality of guide parts 10c are linked to form a screen guide 6c in such as way that the convex portions 13a and concave portions 13b in neighboring guide parts 10c and 10c mate with the rotational axes 13c and bearing holes 13d and they are joined to each other.

Concretely, in the guide part 10C, the pair of convex portions 13a and 13a provided in a protruding condition from one end face 13 is formed so as to have a substantially circular-arc outer surface and has the bearing holes 13d provided in the direction perpendicular to the axial line of the guide part 10C. On the other hand, the pair of concave portions 13b and 13b is formed to sit astride the side face 11a, the inner surface 12a, and the other end face 13 and has the rotational axes 13c provided in a protrusion condition in the direction perpendicular to the axial line of the guide part 10, and the inner surface of the concave portions 13b is also formed so as to be substantially in a circular-arc shape.

Furthermore, also in this screen guide 6C, restriction of the range of circular move by the contact of the outer surface of the convex portion 13a against the inner surface of the concave portion 13b between guide parts neighboring to each other and convex bending of the screen guide 6C toward the side of the screen 5 (side of the inner surface 12a), that is, floating of the screen guide 6C from the opening frame 60 can be prevented as much as possible.

Moreover, tapered portions 13e and 13e are formed at both ends in the direction of axial line (in the axial direction) of the inner wall 12 and smooth bending of neighboring guide parts 10C toward the side of the inner surface 12a, that is, smooth concave bending toward the side of the inner surface 12a of the screen guide 6C are made possible.

1. A winding-up screen device comprising:
a fixed frame fixed to an opening frame of a building;
a movable frame provided so as to be parallel to the fixed frame and movable to and from the fixed frame;
a screen wound around a winding axis, the screen provided so as to extend between the fixed frame and the movable frame, and the screen to be opened and closed by winding and unwinding the screen around the winding axis with the forward and backward movement of the movable frame; and
a screen guide formed so as to be long and bendable, going in and coming out of the inner portion of the fixed frame or the movable frame through the opening provided at the end portion of the fixed frame or the movable frame with the forward and backward movement of the movable frame, and linearly led out along the edge portion of the screen unwound from the winding axis and guiding the edge portion,
wherein a joining part is attached to the screen along the edge portion to be guided by the screen guide,
wherein the screen guide contains a plurality of guide parts in which a joining groove is provided in the axial direction on the inner surface disposed on the screen side and is formed by connecting neighboring guide parts at both sides sandwiching the joining groove on the inner surface so as to be bendable, and
wherein the joining part of the screen unwound from the winding axis is joined to the joining groove of the screen guide led out from the fixed frame or the movable frame so as to slide freely.

2. A winding-up screen device as claimed in claim 1, wherein the joining part is formed in such a way that a plurality of protrusion portions are fixed along one end of a tape-like part fixed to the edge portion of the screen.

3. A winding-up screen device as claimed in claim 1, wherein the guide part contains a pair of connection holes passing through in the axial direction on both sides sandwiching the joining groove on the inner surface and neighboring guide parts are connected to each other by making flexible wire parts pass through in the pair of connection holes.

4. A winding-up screen device as claimed in claim 1, wherein the guide part contains a pair of convex portions and a pair of concave portions for housing the convex portions on both sides sandwiching the joining groove on the inner surface and neighboring guide parts are connected to each other by making the rotational axes and the bearing holes provided in the convex portions and the concave portions mate with each other.

5. A winding-up screen device as claimed in claim 1, wherein convex bending toward the inner surface of the screen guide due to the contact of the end faces in the axial direction of neighboring guide parts is suppressed.

6. A winding-up screen device as claimed in claim 1, wherein one end of the screen guide is fixed to the fixed frame and the screen guide goes in and out of the inner portion of the movable frame with the forward and backward movement of the movable frame, and wherein one end of the screen is held in the movable frame, and the winding axis holding the other end of the screen and winding the screen is supported in the inner portion of the fixed frame so as to be rotational.

7. A winding-up screen device as claimed in claim 1, wherein one end of the screen guide is fixed to the movable frame and the screen guide goes in and out of the inner portion of the fixed frame with the forward and backward movement of the movable frame, and wherein one end of the screen is held in the fixed frame and the winding axis holding the other end of the screen and winding the screen is supported in the inner portion of the movable frame so as to be rotational.

8. A winding-up screen device as claimed in claim 1, wherein the guide part contains a concave groove sitting astride a guide rail provided in a protruding condition on the opening frame on the surface opposite to the inner surface so as to freely slide, and wherein the screen guide led out on the opening frame is guided by the guide rail.

9. A winding-up screen device as claimed in claim 1, wherein the screen is opened and closed by horizontal movement of the movable frame and the screen guide is led out along the lower edge portion of the screen unwound from the winding axis.

10. A winding-up screen device as claimed in claim 9, wherein a slide part is contained at the upper end of the movable frame and the movable frame is suspended from a slide frame fixed to the upper frame of the opening frame by using the slide part so as to freely slide.

11. A winding-up screen device as claimed in claim 1, wherein the screen guide is led out along both edge portions of the screen unwound from the winding axis.

12. A winding-up screen device as claimed in claim 1, wherein a wiring mechanism in which the tension of extended cords maintains the fixed frame and the movable frame in balance is contained.

13. A winding-up screen device as claimed in claim 1, wherein the screen is an insect prevention net.

14. A winding-up screen device as claimed in claim 2, wherein the guide part contains a pair of connection holes passing through in the axial direction on both sides sandwiching the joining groove on the inner surface and neighboring guide parts are connected to each other by making flexible wire parts pass through in the pair of connection holes.

15. A winding-up screen device as claimed in claim 2, wherein the guide part contains a pair of convex portions and a pair of concave portions for housing the convex portions on both sides sandwiching the joining groove on the inner surface and neighboring guide parts are connected to each other by making the rotational axes and the bearing holes provided in the convex portions and the concave portions mate with each other.
